(19) United States
(12) Patent Application Publication
(10) Pub. No.: US 2003/0040931 A1
(43) Pub. Date: Feb. 27, 2003

(54) System, computer, programme, and device of handling data to be used for returning items

(76) Inventors: Maarten Joost De Mol Van Otterloo, Woerden (NL); Nobuyoshi Asaoka, Amstelveen (NL); Sinichiro Otsuka, Amstelveen (NL); Ken-Ichi Nagasawa, Amsterdam (NL)

Correspondence Address: FITZPATRICK CELLA HARPER & SCINTO, 30 ROCKEFELLER PLAZA, NEW YORK, NY, 10112, US

(21) Appl. No.: 10/188,757

(22) Filed: Jul. 5, 2002

(30) Foreign Application Priority Data
Jul. 5, 2001 (EP) 01 116316.9
Jul. 4, 2002 (EP) 02 014 793.0

(51) Int. Cl. G06F 17/60

(52) U.S. Cl. 705/1; 705/402

(57) ABSTRACT

This invention introduces, as one aspect, a system for handling data to be used for returning items; comprising means for creating label data representing a label to be printed for returning items from a customer, means for adding additional information on the label data to be used for restricting usage of the label, means for sending the label data to a customer, means for receiving the additional information contained in the label data corresponding to the printed label to be used, and means for checking the received additional information to decide whether the printed label can be used or not. Accordingly usage of the label copied, modified, or faked would significantly minimised with a little additional cost. Further, checking identification of a returned item, the problem caused by sending other items or fake items can be solved.

### FIELD OF THE INVENTION

This invention relates to a system, a set of computer programmes and a device of handling data to be used for returning items. Especially, this invention relates, but not limited, to returning recyclable items containing consumables, such as toner cartridges, ink bottles and so on.

### BACKGROUND OF THE INVENTION

Recently, collecting recyclable items such as toner cartridges, inkbottles from customers become much more important. For instance, after using toner itself, empty cartridges obviously become disposals. However, some of parts can be reused and some manufacturers have already prepared a plant or a recycle centre to fabricate new toner cartridges filled by toner.

Then, the manufacturer can use such empty cartridge efficiently and can save costs. Also these activities also cause good for the environment and advertisements for these activities make customers conscious of importance on recycling.

One of ordinal method to collect such items is to enclose a pre-authorised label in a container of a new cartridge. Customers can use the label to return their consumed cartridges by using the label, namely the customers can bring empty cartridges to the carrier, for example a post office, a transport firm and so on, to send them to the predetermined plants or other destinations by free. Therefore, the label itself must be pre-authorised by the carrier and the manufacturer. The label has to have information of the name of the carrier, destination to be transported, and identification or certification representing pre-authorisation.

This kind of method has actually worked well and encouraged customers to return their empty cartridges. However, this method includes some drawbacks as follows.

The manufacturer has to make sure about customers' locations and suitable carrier service at the timing of shipping new cartridges and enclose suitable labels for each cartridge. This obviously causes significant workload and relating costs. Accordingly, this kind of method is difficult to be used for collecting small and cheap cartridges or small inkbottles.

Secondly, this may cause customer's workload when the customer moves their location. What have to be done is either the manufacturer send a new label upon request of the customer or the customer brings their consumed cartridges to the carrier located close to the previous location of the customer. This also causes significant workload on both manufacturers and customers and can discourage returning items.

Thirdly, the label can be modified, copied or faked. These kind of conducts may cause significant damage both manufacturers or carriers. Of course, detecting such modification, copying, or like can be possible by utilising certain methods. However, this means all of the carriers have to have instruments to realise such methods and certain amount of database storing customers information. This also causes significant cost for collecting recyclable items.

Further, if somebody uses the proper label for transferring other items or fake cartridges, this also causes damages.

Recently some ideas are raised by utilising the network and Web Sites. For example [4172029: this would be rewritten by formal number] shows the way to utilising internet for collecting empty cartridges. The use of the Internet and Web Site resolve some of the drawbacks set out above.

In short, if the manufacturer can send a label to each customer via Web Site, it is obvious to resolve the problem about workload for enclosing labels and confirming customer's location is solved. This method also resolves the problem caused by the relocation of customer, since the customer can request a label via Web Site with informing the new location.

However, this method cannot solve the problem caused by the possibility of modifying, copying, and faking labels, rather this method enlarge this kind of problem. For example, the customer can easily print a label several times. Since the printed label printed by printers owned by customers has normally lower quality and lower resolution than that printed by the printing company, it becomes easier to manipulate, modify, or fake the label.

Further, this method does not solve the problem caused by sending other items or fake cartridges by using the label.

### SUMMARY OF THE INVENTION

This invention had been done for resolving drawbacks describing above.

The object of this invention is to prevent a system for returning items from being suffered by copy, modify, or fake the labels to be used for returning items.

Another object of this invention is to minimise the cost to encourage customers to return their consumed items without significant additional workloads of the manufacturer and customer.

To accomplish the above objects, this invention introduces, as one aspect, a system for handling data to be used for returning items; comprising means for creating label data representing a label to be printed and to be used for returning items from a customer, means for adding additional information on the label data to be used for restricting usage of the label, means for sending the label data to a customer, means for receiving the additional information contained in the label data corresponding to the printed label to be used, and means for checking the received additional information to decide whether the printed label can be used or not.

According to this system, usage of the label copied, modified, or faked would significantly minimised with a little additional cost.

As another aspect of this invention, this invention introduces a set of computer programmes to be used for returning items, which comprising programme for creating label data representing a label to be printed and to be used for returning items from a customer, programme for adding additional information on the label data to be used for restricting usage of the label, and programme for sending the label data to a customer, programme for receiving the additional information contained in the label data corresponding to the printed label to be used, and programme for checking the received additional information to decide whether the printed label can be used or not.

As further aspect of this invention, this invention introduces a device for handling data to be used for returning items, the device being connected to a network to which a device of a customer is connected, the device comprising, a label creator for creating label data representing a label to be printed by the customer and to be used for returning items from a customer, an adder for adding additional information on the label data to be used for restricting usage of the label, a sender the label data to a customer, a receiver for receiving the additional information contained in the label data corresponding to the printed label to be used, and a checker for checking the received additional information to decide whether the printed label can be used or not

These aspects minimise further workload of the manufacturer side and also the customer side. These aspects may be realised by, for example, adding unique additional information for each label by bar codes or watermarking.

These aspects may also be realised by, for example, using the additional information for checking expiring date, for example, a later date for a certain period from time at which sending the label data to the customer, using the additional information and a tag for checking whether the label has been used or not, or using the additional information for checking whether combination of the additional information and product information to be return is proper or not.

These aspects may also be realised by, for example, receiving information representing a printed label to be used by the customer and checking whether the received information is proper or not. Such information representing label may be image data and the image data is decoded to reproduce the additional data during checking, a unique data by decoding either bar codes or watermarks, or the additional data which has been decoded from the printed label.

These aspects may also be accomplished by sending a massage to warn the customer that the label data cannot be used in response to the decision made by said checking means.

Further object of this invention is to minimise the cost to encourage customers to return their consumed items without significant additional workloads or costs beard by the carrier.

To accomplish the above objects, this invention introduces, as one aspect, a device for handling data to be used for returning items, the device being connected to a network to which a device of manufacturer is connected, the device of manufacturer sending label data presenting a label to be printed and to be used for returning items from a customer with unique information for each label to the network, the device comprising a scanner for scanning a printed label to obtain image data corresponding thereto, a sender for sending the image data to the device of manufacturer so that the image data is to be checked; and a receiver for receiving the result of checking whether the unique information contained in the image data of the printed label can be sued or not from the device of manufacturer.

To accomplish the above objects, this invention introduces, as one aspect, a device for handling data to be used for returning items, the device being connected to a network to which a device of manufacturer is connected, the device of manufacturer sending label data presenting a label to be printed and to be used for returning items from a customer with unique information for each label to the network, the device comprising a reader for reading a printed label to obtain the unique information corresponding thereto, a sender for sending the unique information to the device of manufacturer so that the unique information is to be checked, a receiver for and receiving the result of checking whether the unique information of the printed label can be used or not from the device of manufacturer.

These aspects minimise further costs or workload of the carrier side and also the customer side.

Further object of this invention is to prevent as system for returning items from being suffered by transferred other items, fake cartridges, exchanged label or stolen label.

To accomplish the above objects, this invention introduces, as one aspect, a system for handling data to be used for returning items, which comprises means for creating label data representing a label to be printed for returning an item from a customer, the label data including unique data, means for sending the label data to a customer, means for receiving identification data identifying an item to be returned by the customer, means for storing the identification data in association with the unique data, means for receiving identifying data from a returned item, means for checking the received identifying data from the returned item to decide whether the returned item is proper or not by referring the identification data stored in said storing means, and means for calling the unique data associating with the identification data if said checking means decides that the returned item is improper.

According to this system, transferred other items, fake cartridges, exchanged label or stolen label is easily found and prevent damages causing to both manufacturer and recycling centre.

As further aspect of this invention, this invention introduces a set of computer programmes for handling data to be used for returning items, which comprises programme for creating label data representing a label to be printed for returning an item from a customer, the label data including unique data, programme for sending the label data to a customer, programme for receiving identification data identifying an item to be returned by the customer, programme for storing the identification data in association with the unique data in a storage, programme for receiving identifying data from a returned item, programme for checking the received identifying data from the returned item to decide whether the returned item is proper or not by referring the identification data stored by storing means, and programme for calling the unique data associating with the identification data if said checking means decides that the returned item is improper.

Other features or aspects would be clarified by following detailed embodiments with reference with of drawings.

### BRIEF DESCRIPTION OF THE DRAWINGS

FIG. 1 shows a block diagram showing elements of an example of a whole network system in which this invention is implemented.

FIG. 2 shows a time chart of processes carried out for sending a label to the customer in the system shown in FIG. 1.

FIG. 3 shows a flow chart representing programmes executed by the server of the manufacturer shown in FIG. 1 to realise the processes shown in FIG. 2.

FIG. 4 shows a displayed page for customers, by the programmes corresponding to FIG. 3, to be used for inputting whether the customer has been already registered or not.

FIG. 5 shows a displayed page for customers, by the programmes corresponding to FIG. 3, to be used for inputting customer's information.

FIG. 6 shows a displayed page for customers, by the programmes corresponding to FIG. 3, to confirm the registration.

FIG. 7 shows a displayed page for customers, by the programmes corresponding to FIG. 3, to be used for inputting registered information of the customer.

FIG. 8 shows a label affixing onto cartridges.

FIG. 9 shows a label printed in accordance with the programmes corresponding to FIG. 3.

FIG. 10 shows a time chart of processes carried out for checking a label to be used in the system shown in FIG. 1.

FIG. 11 shows a flow chart representing programmes executed by the server of the manufacturer shown in FIG. 1 to realise the processes shown in FIG. 10.

FIG. 12 shows a time chart of processes carried out for checking a label affixing to the cartridge.

FIG. 13 shows a flow chart representing programmes executed by the server of the manufacturer shown in FIG. 1 to realise the processes shown in FIG. 12.

### DETAILED DESCRIPTION OF PREFERRED EMBODIMENTS

To make it easy to implement this invention, only some of embodiments or aspects of this invention are described as below.

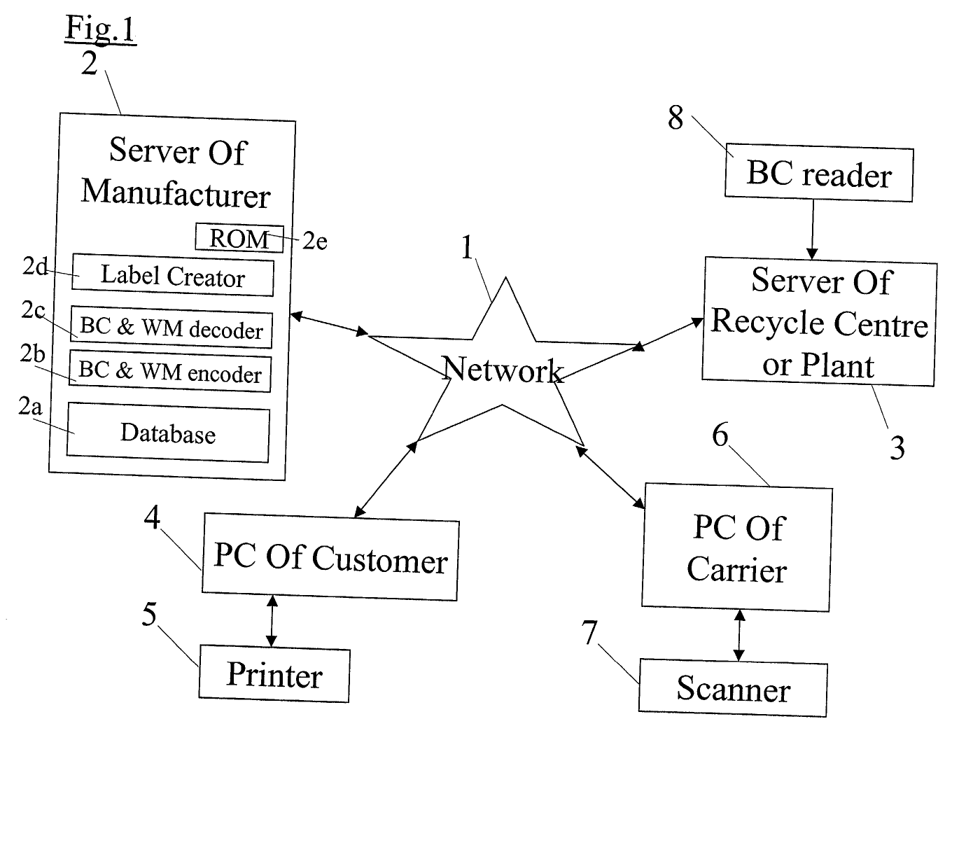

FIG. 1 shows a network system connected to a plurality of computers located in some instruments. In this specification, word “computer” will sometimes to be used as a central processing unit (CPU) itself or one including surrounding hardware and software. According to this embodiments, a network 1 shall connect at least a computer located in a server of manufacturer (hereinafter “Manufacturer Server”) 2, a computer located in a personal computer of the customer (hereinafter “Customer PC”) 4, a computer located in a server of the recycle centre or plant (hereinafter “Plant Server”) 3, and a computer located in a personal computer of the carrier (hereinafter “Carrier PC) 6.

Besides, although only one Carrier PC 6 and one Plant Sever 3 are shown in the FIG. 1, there are a plurality of Carrier PCs and Plant Servers connected to the network 1.

The personal computer used in this specification means a set of instruments including a display, an input device, such as a keyboard and a mouse, a CPU, a disc drive and others inherently included in the personal computer. Customer PC 4 is connected to a printer 5 and Carrier PC 6 is connected to a scanner 7. The Plant Server 3 is connected to a barcode reader (BC reader) 8.

The server used in this specification means a set of devices including a computer and other electric instruments prepared so as to create a Web Site producing one or more Web Page composed of texts, pictures, photographs, and/or objects to be displayed. The Manufacturer Server 2 includes a database 2a in which information of the customer is stored, an encoder 2b for encoding information to create barcodes (BC) and watermarks (WM), a decoder 2c for decoding BC and WM for restoring the original information, and a label creator 2d for creating image data of the label to be sent including the information encoded by the encoder 2b. The database 2a further stores all serial numbers of shipped cartridges that have been distributed from the manufacturer.

Programmes, which control processes executed by the Manufacturer Server, are stored in a ROM 2e, located in the Manufacturer Server 2, and are read in accordance with proceeding processes. Similarly, programmes controlling processes executed by the Customer PC 4, the Carrier PC 6, and the Plant Server 3 are stored therein, although memories are not shown in the Customer PC 4, the Carrier PC 6, and the Plant Server 3 of the FIG. 1.

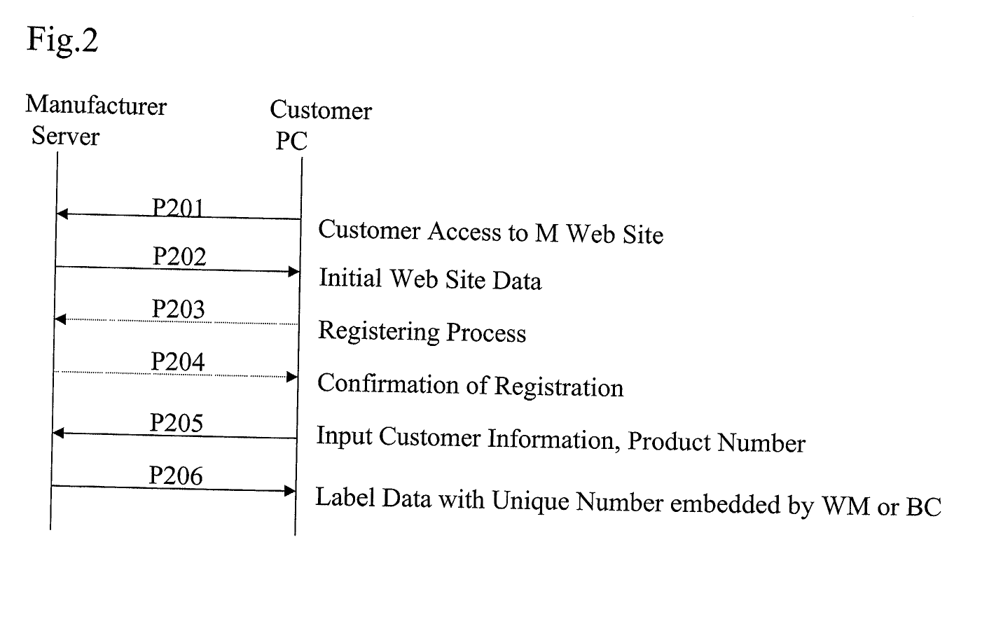

Firstly, for making understanding easy, rough processes are described by referring FIG. 2. FIG. 2 represents order of processes, which have to be carried out for sending a label to the Customer PC 4 in the system shown in FIG. 1. A process P201 represents an access made by the customer (Customer PC 4) and a process P202 represent sending an initial Web Page to the Customer PC 4.

If the customer has already been properly registered, the customer can input its information at a process P205. However, if the customer has not been registered, registering processes P203 and P204 are taken. The process P203 represents sending information necessary to register the customer and the process P204 represents sending the information for confirming the registration.

The process P205 represents sending information about customer including Product Number, including such as a name of the product (printer), a serial number thereof and serial numbers of cartridges to be returned. The information sent at the process P205 is described later. If the information sent in the process P205 is appropriate, the Manufacturer Server send the Label Data representing a label to be used for returning items. In this embodiment, such Label Information is sent with additional information embedded by using barcodes or watermarks.

Obviously, there exist many correspondences between the Manufacturer Sever 2 and Customer PC 4. However, in the FIG. 2, such correspondences are often now shown, but described below.

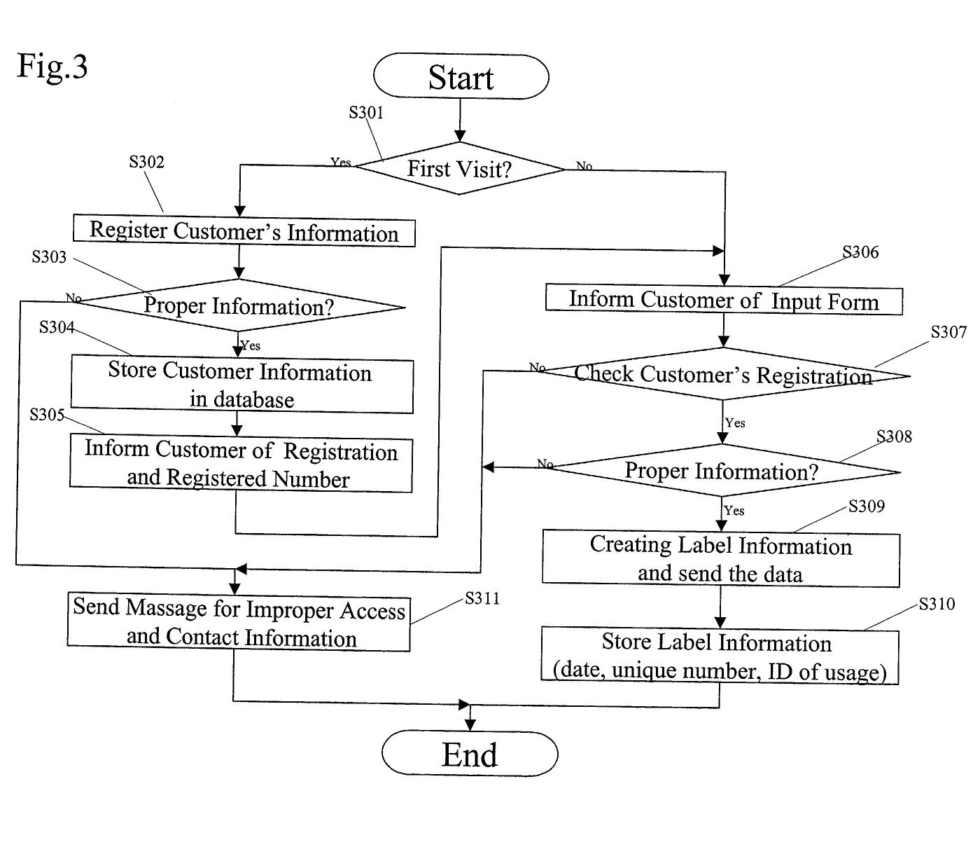

To make these processes carried out in this embodiment detailed, concrete processes carried out in this embodiment are now described by using FIGS. 3 through 8.

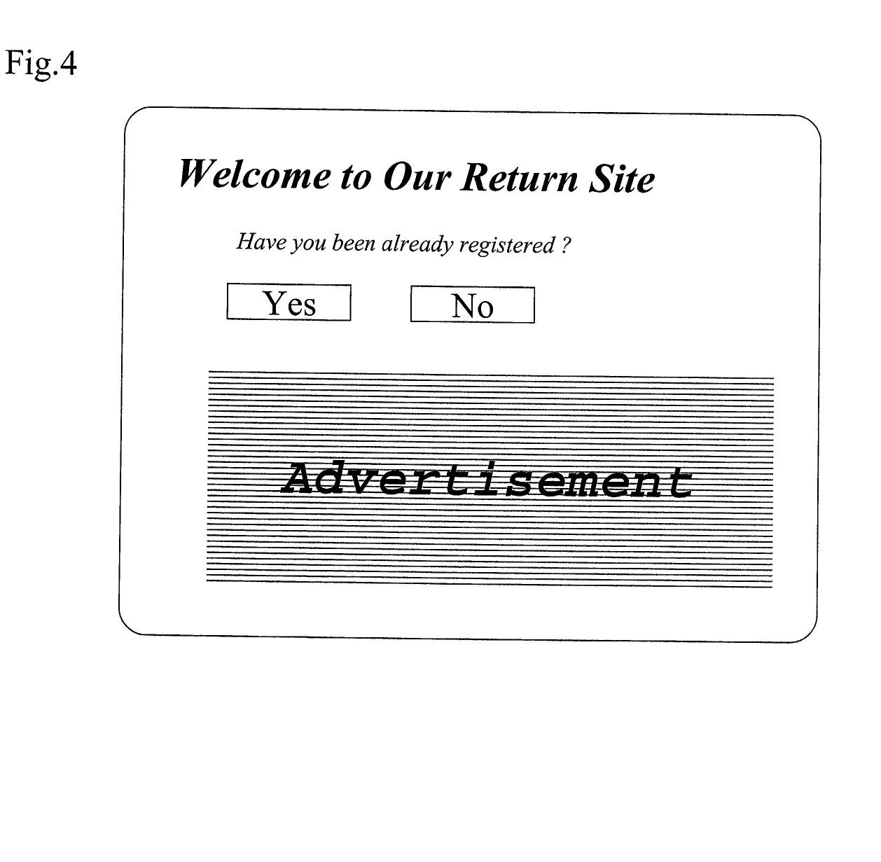

First, when the customer access the Web Site created by the Manufacturer Server 2 via Customer PC 4, data representing the Web Page shown in FIG. 4 is sent to the Customer PC 4 from the Manufacturer Server 2. Obviously the Manufacturer Server has a function to make up such a Web Page by using well-known method, namely VRML, HTML, XML or other known languages.

As shown in the FIG. 4, such a Web Page may include some text and pictures for the purpose of advertisement. According to this embodiment, this page shows operable rectangular areas with “Yes” and “No” to be clicked by the customer by using input devices with seeing the displayed page. Since, the text “Have you been already registered?” is shown via a display included in the Customer PC 4, “Yes” means that the customer declares his or her registration. In the step S301 of the FIG. 3, the Manufacturer Server receives the result of such customer's declaration.

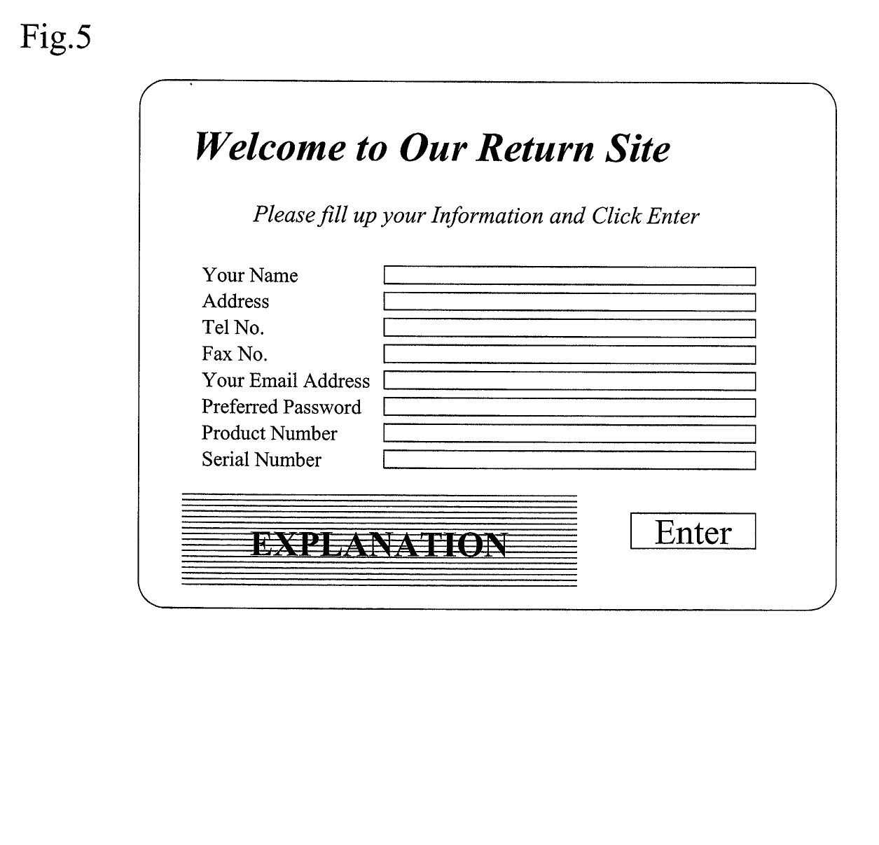

If the customer clicks “No” in a step S301, process goes to a step S302 for registering the customer's information. In the step S302 Manufacturer Server 2 automatically prepare the next Web Page as shown in the FIG. 5. As shown in the FIG. 5, this Web Page is prepared to make customer input his or her information, including a name, an address, a telephone number, a facsimile number, an email address, a password, a product number of a printer owned by the customer, and a serial number of the printer. Besides, according to the FIG. 5, explanation how to fill up such information is described below input columns for these information.

When the customer clicks “Enter” after filling up these information, all of the information shown in FIG. 5 is sent to the Manufacturer Server 2 in the step S302. Then the Manufacturer Server 2 checks whether some of the information is proper or not in a step S303. The Manufacturer Server 2 refer the database for checking whether the input product number actually exists and the input serial number comply with a rule of numbering by checking a number of digits or its order, for example.

If the check executed in the step S303 indicates that information is proper, the process goes to a step S304. If not, process goes to a step S311. In the step S311, the Manufacturer Server 2 sends another Web Page to the Customer PC 4 which includes massage that this access is made with improper information. The Web Page sent in the step S311 also includes the massage informing of contact information by which the customer knows how to solve this problem. Then process is finished.

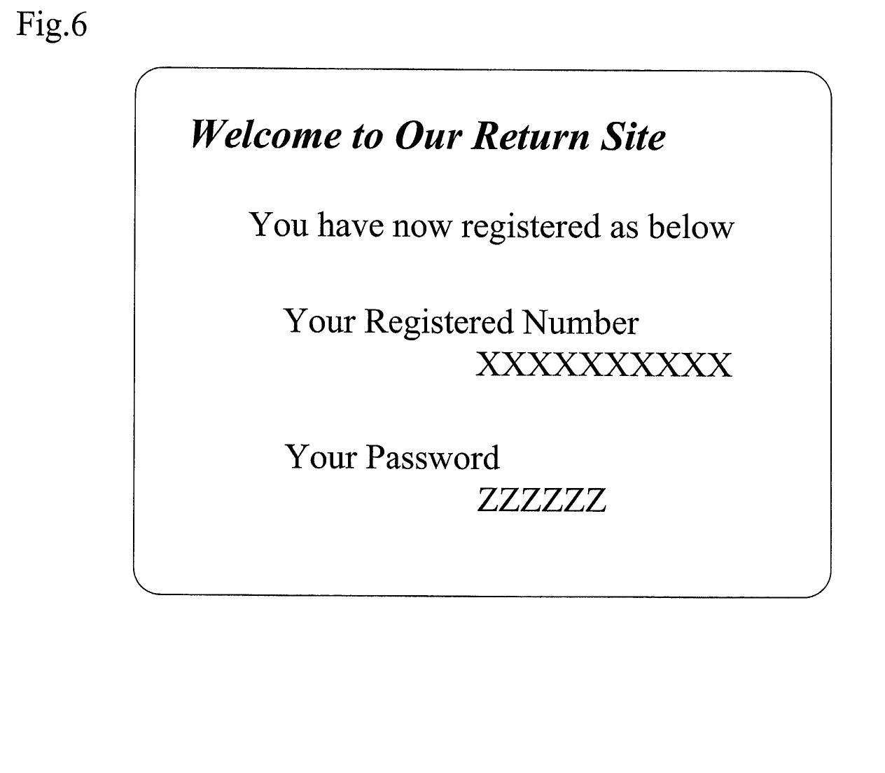

On the other hand, if information is proper, the Manufacturer Server 2 stores the information sent from the customer into the database 2a in a step S304 and go to a step S305. In the step S305, the Manufacturer Server 2 send another Web Page as shown in FIG. 6 informing that the registration has been done with a registered number of the customer and a corresponding password thereto, and go to a step S306 automatically.

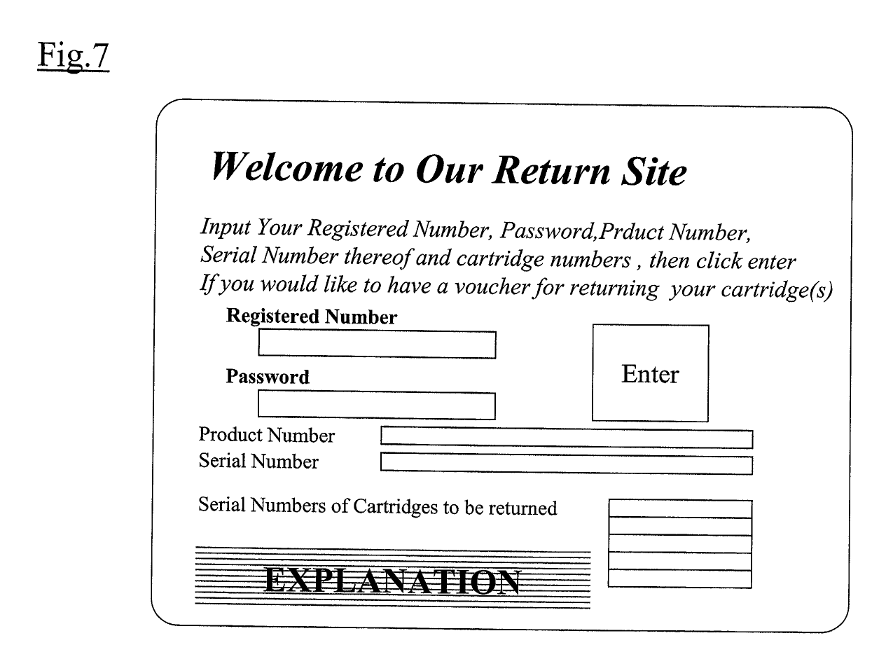

If the customer clicks “Yes” in the step S301, the process goes to the step S306 as well. In the step S 306, the Manufacturer Server 2 send another Web Page as shown in FIG. 7 asking the customer fill up the registered numbers, the password, a product number of a cartridge (a cartridge name), the serial numbers of cartridges to be returned. As shown in FIG. 7, explanation how to fill up such information is similarly displayed and described to FIG. 5.

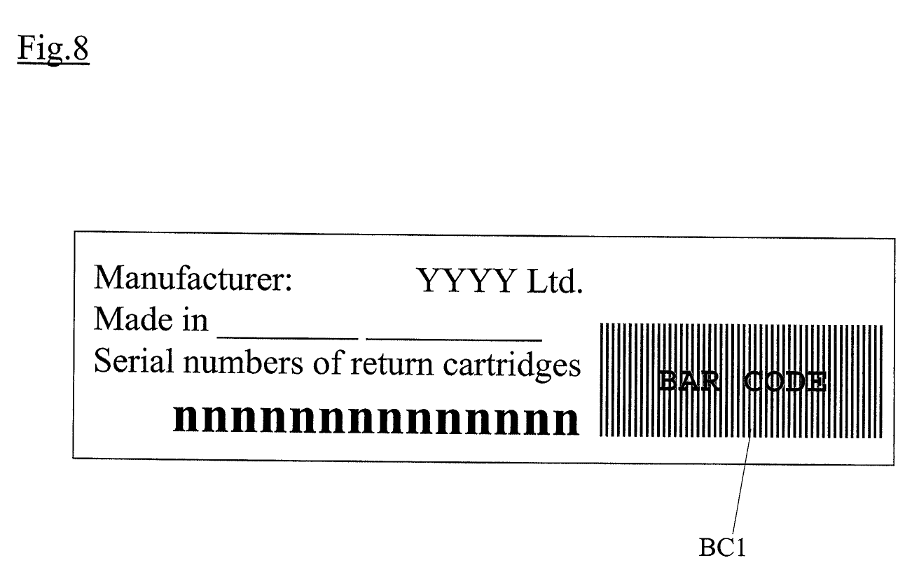

Whilst the customer has to fill up all information shown in FIG. 7 in the step S306, the customer can refer a label shown in FIG. 8, which is affixed onto the cartridge. The label affixed onto the cartridge usually shows a name of the manufacturer and a location of manufacturing. In this embodiment, the manufacturer further visibly adds a serial number of the cartridge and adds a barcode BC 1 representing information including the cartridge name and the serial number of the cartridge.

In this step S306, it is possible to ask the customer just registered by the steps 303305 only information excluding the product number and the serial number thereof, since it is supposed that these are not changed.

After the customer fills up the information shown in FIG. 7 and clicks “Enter”, the Manufacturer Server 2 checks whether the input register number and the pass word have been registered or not by referring the database 2a thereof in a step S307. Following the step S307, in a step S308, the Manufacturer Server 2 checks whether the input serial number and the product number are proper or not as same as the step S303. In this step S308, the Manufacturer Server 2 further checks whether the input serial numbers of cartridges are stored (registered) in the database 2a respectively. If each input serial number is registered (stored) in the database 2a, the Manufacturer Server 2 confirms that the input serial number of cartridge is proper. However, if not, the Manufacturer Server 2 realises that each input serial number is improper.

If the input product number, the serial number, and all serial numbers of cartridges to be returned are proper as described above and the customer has already registered with the registered number and a proper password, the process goes to a step S309. Otherwise, the process goes to the step S311 and the process is finished after sending the Web Page including massages as mentioned above.

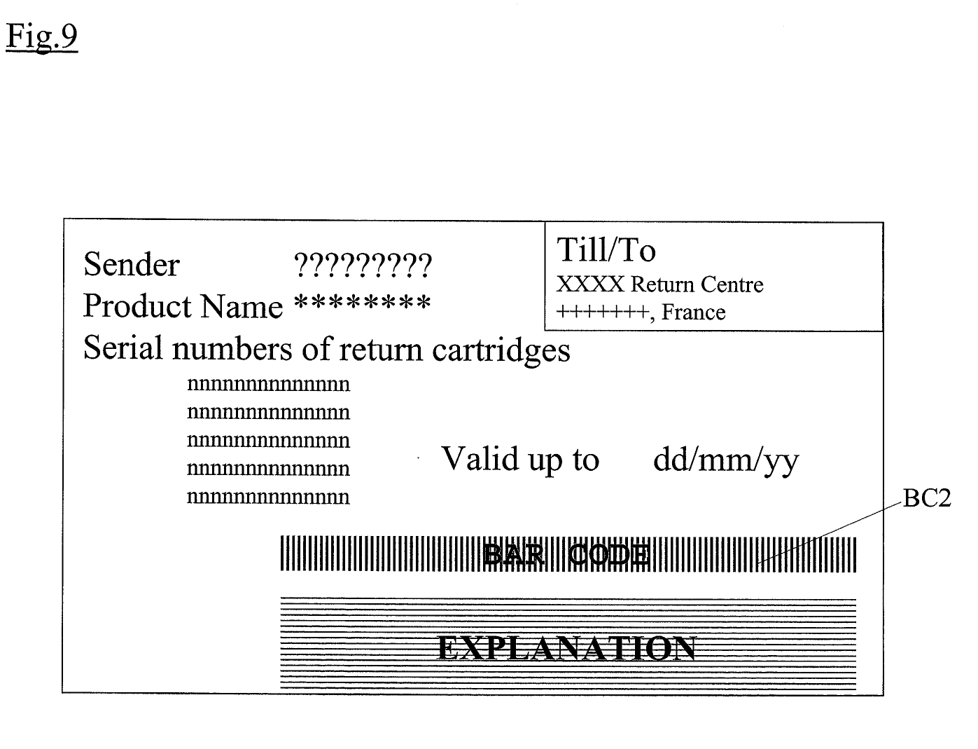

On the other hand, in the step S309, a pre-authorised label to be used for returning cartridges shown in FIG. 9 is created in the Manufacturer Server 2. In this step S309, the Manufacturer Server 2 firstly creates certain unique information about the label including a unique number for each label, date indicating when the label is sent (sending date), and the product number. These information, namely the unique number, the date, and the product number, are supplied to the encoder 2b.

Information including the registered number, a name of the customer as a sender, the product number, serial numbers of the cartridges, and the sending date are also supplied to the label creator 2d. The label creator 2d creates image data as shown in the FIG. 9 by using such information. As for a date for expiration, namely the date shown next to the text of “Valid up to” is calculated by using the sending date. For example, the expiration date is set as a date 2 month after the sending date.

As for the name of the Carrier and the destination shown under the text of Till/To are created in the label creator 2d by referring database 2a to select a suitable Carrier and a suitable destination, namely a plant or recycle centre, based on registered address of the customer input in the step S302.

As for the barcodes, the label creator 2d receives the encoded barcodes BC2 from the BC & WM encoder 2b and simply adds the encoded barcodes BC2 including the information described above, namely the unique number, the expiration date and the product number, on the label as shown in the FIG. 9. After adding the encoded barcodes BC2, image shown in the FIG. 9 is once sent to the BC & WM encoder 2b and is encoded to add watermarks for embedding the information described above latently. Finally, the BC & WM encoder 2d sends the watermarked image to the label creator 2b again and the encoded label data is sent to the Customer PC 4 from the Manufacturer Server 2 in the step S309.

Immediately after sending the label data, the Manufacturer Server 2 stores the Label Information as a combination of the unique number, the expiration date, the product number, and serial numbers of cartridges in the step S310 and ends the process.

As described above, the label data sent from the Manufacturer Server 2 includes information to be used for restricting usage of each label. Accordingly improper usage of the label is effectively prohibited as described later.

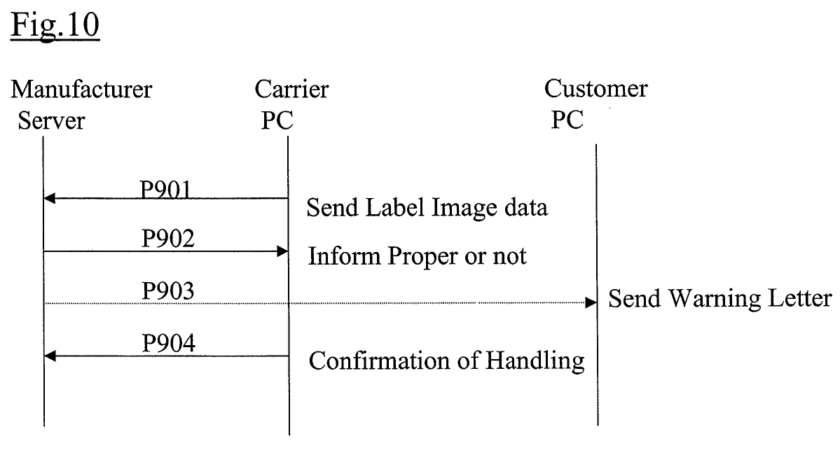

After sending the label data, the customer instructs the Customer PC 4 to send the label data to a printer 5 for printing the label corresponding to the label data. The customer takes the printed label to the carrier, Then, the customer asks the carrier to transport the items to the designated destination displayed on the printed label. FIG. 10 shows rough processes taken after the customer asks the carrier to transport for making understanding easy.

The carrier receiving the printed label from customer firstly scans the printed label by using the scanner 7 as image data. The carrier make the Carrier PC 6 to send the imaged data of the label scanned by the scanner 7 to the Manufacturer Server 2 via the network 1 in a process P 901 shown in the FIG. 10. The manufacturer Server 2 checks whether the label is proper to be used or not by using the image data of the label received.

As mentioned above, the image data of the label included information encoded as the bar codes BC2 and encoded by watermarking. The Manufacturer Server 2 sends the image data received by the Carrier PC 6 to the BC & WM decoder 2c to decode the information including the unique number, the expiration date and the product number. Then the Manufacturer Server 2 checks whether the label to be used is proper or not and sends checked result to the Carrier PC 6 in a process P902 shown in the FIG. 10.

If the Manufacturer Server 2 judges that the label to be used is improper one, the Manufacturer Server 2 send a warning letter to the Customer PC 4 by using email system via the network 1 in a process P903. On the other hand, the Manufacturer Server 2 judges that the label to be used is proper one, the Carrier PC 6 informs the Manufacturer Server 2 to confirm that the carrier handle the consumed items to transport to the destination shown in the label in a step P904.

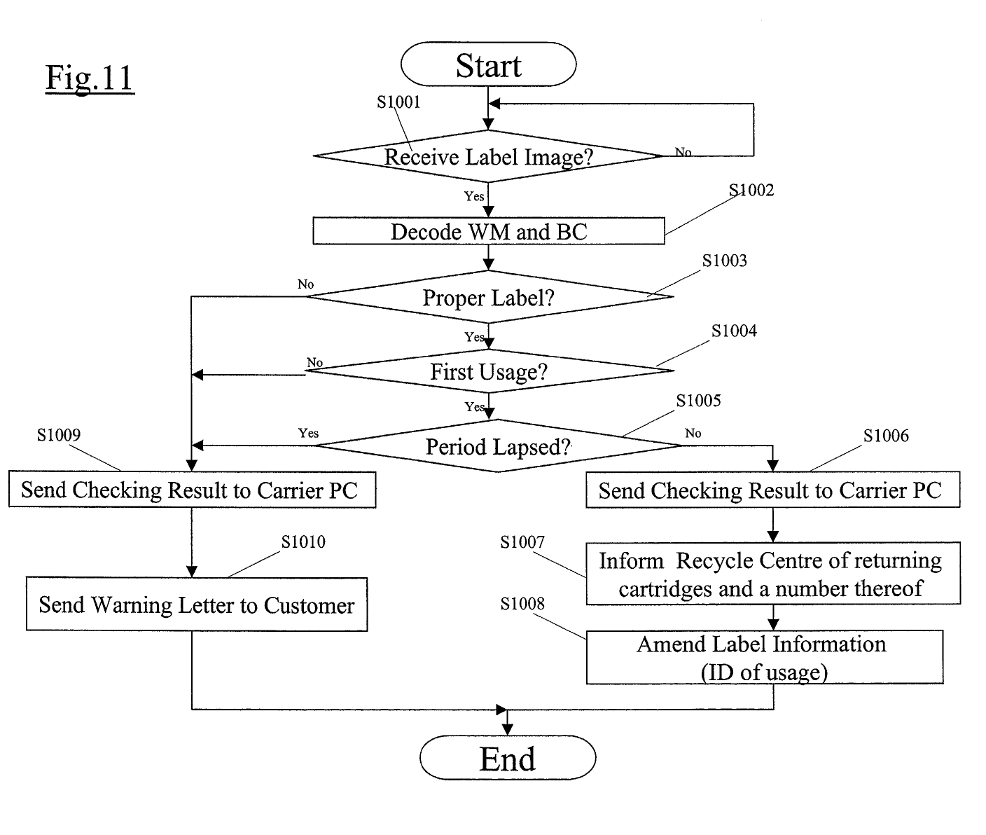

To make these processes carried out in this embodiment detailed, concrete processes carried out in this embodiment are now described by using FIG. 11. A flow chart shown in the FIG. 11 represents programmes executed in the Manufacturer Server 2.

As shown in the FIG. 11, when the Manufacture Server 2 receives the image data of the label from the Carrier PC 6, the process is shifted from a step S1001 to a step S1002. In the step S1002, the Manufacturer Server 2 sends the image data of the label to the BC & WM decoder 2c. The BC & WM decoder 2c decodes the barcodes BC2 contained in the image data and decodes the watermarks embedded in the image data. The decoder 2c outputs the information including the unique number, the expiration date and the product number.

In accordance with the decoded information, the Manufacturer Server 2 judges whether the label to be used is proper or not in steps S1003, S1004 and S 1005. In the step S1003, the Manufacturer Server 2 compares the decoded information obtained from barcodes BC2 with the decoded information obtained from the watermarks. If the decoded information is different from each other, the Manufacturer Server 2 judges that the label to be used is improper, since there is some possibility of modification of the label, especially that the barcodes BC2 are modified. Also in the step S1003, the Manufacturer Server 2 checks whether the combination of the product number and the unique number is stored in the database 2a. If the combination obtained from the decoded information is not stored, the Manufacturer Server 2 judges that the label to be used is improper, since there is some possibility of modification of the label. If the Manufacturer Server 2 judges that the label is improper in the step S1003, the process goes to a step S1009.

On the other hand, if the Manufacturer Server 2 judges that the label is proper in the step S1003, the process goes to a step S1004. In the step S1004, the Manufacturer Server 2 checks by referring the database 2a whether the label having the unique number has been used or not by checking the unique code has been tagged or not. If it has been used, the Manufacturer Server 2 judges that the label is improper, since it is possible that the label to be used has been copied or modified, If it is judged in the step S 1004 that the label is improper, the process goes to the step S1009. If not, the process goes to the step S1005.

The customer and the carrier can see the expiration date shown in the label to be used. Therefore only the fact that the label data sent from the Manufacturer Server 2 to the Customer PC 4 includes such visible data about the expiration date is effective to prevent from improper usage of the label. For example, even it somebody steels or accidentally finds lost labels, these lost labels can not be used. Further this embodiment cares about this kind of usage, even the carrier overlooks the expiration of the label or displayed expiration date has been modified.

In the step S1005, the Manufacturer Server 2 checks the expiration date obtained from the image data of the label and judge whether the label is still usable or not. This prevents from improper usage of the label modified or edited. If the expiration date obtained from the image data of the label is gone, the process goes to the step S1009.

In the step S1009, the Manufacturer Server 2 sends the checking result that the label is improper to the Carrier PC 6. Then, the carrier can reject using the improper label. Following the step S 1009, the manufacturer server 2 also send the warning letter to the customer corresponding to the unique number to inform that the label send to the customer may be modified, copied or faked in a step S1010. After the process of the step S1010 is executed, the Manufacturer Server 2 ends the process.

On the other hand, if the label to be used is proper in steps S1003, S1004 and S1005, the process goes to a step S1006. In the step S1006, the Manufacturer Server 2 sends the checking result that the label is proper to the Carrier PC 6. Then, the carrier can accept using the label. Accordingly usage of the label is authorised and the usage will carried out. The authorised label is affixed to a box, which contains cartridges to be returned. Therefore, the Manufacturer Server 2 informs the Plant Server 3 of the fact that the products (empty cartridges) will reach the plant or recycle centre and in a step S1007. This helps the recycle centre or the plant to control their recycling work.

Following the step S1007, the Manufacturer Server 2 rewrites the database 2a in a step S1008 by tagging the unique code so as to store the fact that the label corresponding to the unique number has been used. This information is used in the step S1004 later. After the step S1008, the process ends.

As described above, any improper usage of the label would be prohibited. Concretely, using modified labels, fake labels, lost labels or copied labels becomes impossible. Accordingly, this embodiment described above resolves the drawback caused by the possibility of modifying, copying, and faking labels, even the label is sent to the customer as the label data via the network.

Even if the proper label is used at the carrier and cartridges are sent to the recycle centre or plant, there is further possibility that the recycle center or plant are sometimes received cartridges from other manufacturers, counterfeits cartridges, or already recycled cartridges. The recycle plant cannot recycle these kinds of cartridges.

It is possible, at the recycle centre or plant, to check if the serial number of cartridge contained in the box is shown on the label. However, such manual check takes time and also it is difficult to find the corresponding box to the cartridge after taking out the cartridges from the box.

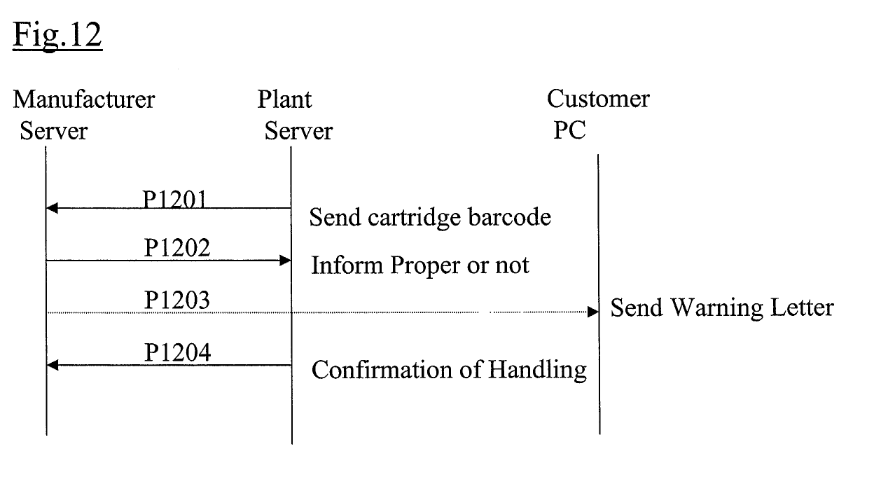

In this embodiment, it is possible to automatically detect improper cartridges has been returned (False Return) to the recycle centre or plant, to find the customer to be involved in the False Returns, and to warn such customer. FIG. 12 shows rough processes taken after the recycle centre or plant receives cartridges for making understanding easy.

The recycle centre or plant firstly takes out cartridges from the box and scans the barcode BC 1 by using the barcode reader 8 and obtain serial numbers of returned cartridges. The centre or plant make the Plant Server 3 to send the serial numbers of cartridges reproduced by the BC reader 8 to the Manufacturer Server 2 via the network 1 in a process P 1201 shown in the FIG. 12. The Manufacturer Server 2 checks whether the returned cartridges are proper or not by using the reproduced serial numbers.

Then the Manufacturer Server 2 checks whether the serial numbers of returned cartridges are proper or not and sends checked result to the Plant Server 3 in a process P1202 shown in the FIG. 12.

If the Manufacturer Server 2 judges that the returned cartridges are improper, the Manufacturer Server 2 send a warning letter to the Customer PC 4 by using email system via the network 1 in a process P1203. On the other hand, the Manufacturer Server 2 judges that the returned cartridges are proper, the Plant Server 3 informs the Manufacturer Server 2 to confirm that the recycle centre or plant proceed such cartridges for recycling them in a step P1204.

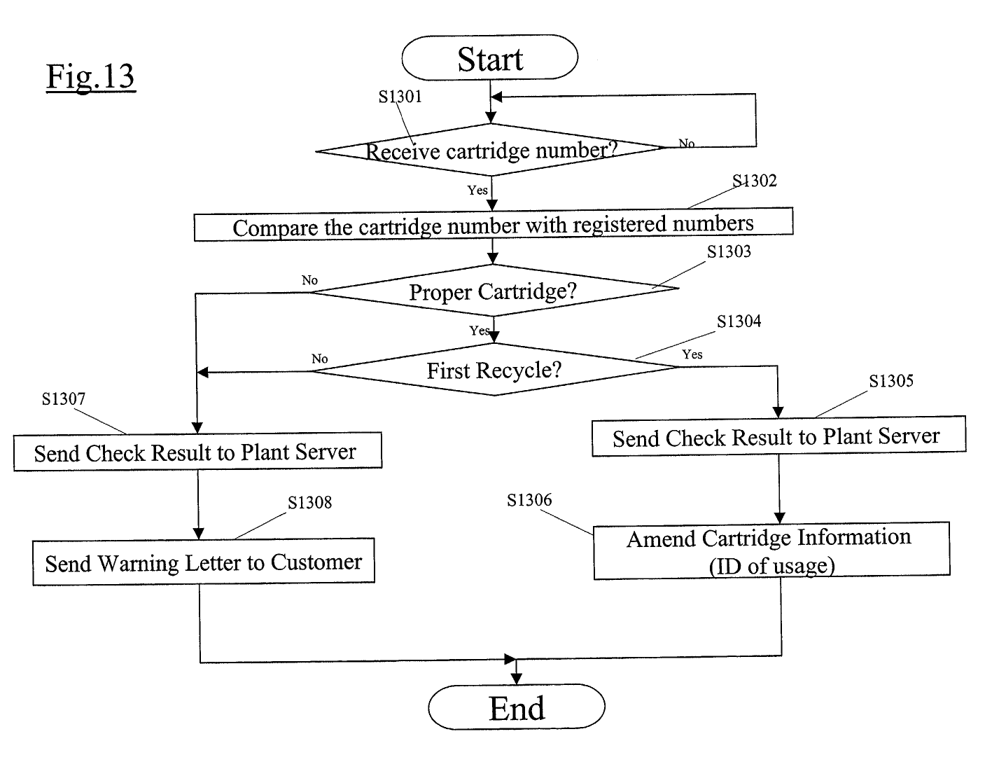

To make these processes carried out in this embodiment detailed, concrete processes carried out in this embodiment are now described by using FIG. 13. A flow chart shown in the FIG. 13 represents programmes executed in the Manufacturer Server 2.

As shown in the FIG. 13, when the Manufacture Server 2 receives the serial numbers of returned cartridges from the Plant Server 3, the process moves from a step S1301 to a step S1302. In the step S1302, the Manufacturer Server 2 compares the reproduced serial numbers with stored serial numbers in combination with the unique code and the product number. The Manufacturer Server 2 judges whether the reproduced serial numbers are stored with the label data (including the unique code, the product number and the expire date) or not. If each reproduced serial number is not stored with the label data in the database 2a, it is judged that the returned cartridge is not proper in a step S1303. Of course, in the step S1303, if each reproduced serial number is stored with the label data in the database 2a, it is judged that the returned cartridge is proper.

If the Manufacturer Server 2 judges that the label is proper in the step S1003, the process goes to a step S1304. In the step S1304, the Manufacturer Server 2 checks by referring the database 2a whether the return cartridge having the reproduced serial number has been recycled or not by checking the serial number stored with the label data has been tagged or not. It can be checked by referring a tag attached to each of serial numbers, which are stored with the label data. If it has been recycled, the Manufacturer Server 2 judges that the returned cartridge is improper, since it seems that cartridges to be returned have been exchanged, the label has been stolen, or the label has been exchanged or modified. If it is judged in the step S1304 that the returned cartridge is improper, the process goes to the step S1307. If not, the process goes to the step S1305.

The worker in the recycle centre or plant can judge whether the returned cartridge see the expiration date shown in the label to be used. Therefore only manual detection of the False Return carried out by workers in the recycle centre or plant is effective to prevent from placing such improper cartridge onto the recycling line. For example, even it somebody exchanges cartridges or exchanges both the label and the cartridges, such improperly returned cartridges are not to be placed on the recycle line and are then set apart for destruction or for being sent back.

In the step S1307, the Manufacturer Server 2 sends the checking result to the Plant Server 3. Then, the recycle centre or plant can set apart such improperly returned cartridges for destruction or for being sent back to the customer. Following the step S1307, the Manufacturer Server 2 also send the warning letter to the customer corresponding to the unique number to informi that the cartridge may be exchanged, the label has been exchanged or stolen in a step S1308. After the process of the step S1308 is executed, the Manufacturer Server 2 ends the process.

On the other hand, if the returned cartridge is proper in steps S1303 and, S1304, the process goes to a step S1305. In the step S1305, the Manufacturer Server 2 sends the checking result that the returned cartridges is proper and can be recycled to the Plant Server 3. Then, the recycle centre or plant can place such a cartridge onto the recycling line.

Following the step S1305, the Manufacturer Server 2 rewrites the database 2a in a step S1306 by tagging the serial number stored with the label data so as to store the fact that the cartridge corresponding to the serial number stored with the label data has been recycled. This information is used in the step S1304 later. After the step S1306, the process ends.

As described above, any improper return of the cartridges wouldnot cause significant problem. Concretely, exchanging cartridges, exchanging the labels, or steeling the label becomes not so big problem, even once cartridges are taken out from the box and it become impossible to find the label for such cartridges.

In the embodiment described above, the BC & WM decoder 2c is located in the manufacturer Server 2. However, there is another option that the BC & WM decoder 2c is located in the Carrier PC 6 by sending a decoding programme from the Manufacture server 2 to the Carrier PC 6 or by installing such a program. In this option, installing or sending programme to each of the Carrier PCs would be necessary and this cause some workloads. However, in term of corresponding time, this option has advantage. Because, if the Carrier PC can decode BC and WM, only the decoded information is transferred from the Carrier PC6 to the Manufacturer Server 2. Therefore, the corresponding time is reduced.

The above-described embodiments restrict the usage of the printed label by checking all of whether the label is expired, whether the label has been used, and whether the label is proper. However, only a system, a programme and a device in which one kind of checking is carried out for restricting the usage of the label are with in the scope of this invention.

Although limited embodiments are only described in the specification, it is possible to change the embodiments to the extent of the scope of claims.

As described above, this invention creates or introduces a system, programme or device which gives advantages as follows.

The manufacturer does not have to make sure about customers' locations and suitable carrier service at the timing of shipping new cartridges and to enclose suitable labels for each cartridge. This reduces workload and relating costs.

It become unnecessary for the manufacturer to send a new label upon request of the customer to its new location or for the customer to bring their consumed cartridges to the carrier located close to the previous location of the customer. This also reduces significant workload on both manufacturers and customers and can encourage returning items.

The damage on both manufacturers and carriers caused by the modified label, the copied label or the fake label can be avoided without significant increase of costs and workloads. Also the damage on both manufacturer and the recycle centre or plant caused by the exchanged cartridge, the exchanged label or the stolen label, namely False Return can be significantly reduced.

What is claimed is:

1. A system for handling data to be used for returning items; comprising
means for creating label data representing a label to be printed for returning items from a customer;
means for adding additional information on the label data to be used for restricting usage of the label;
means for sending the label data to a customer;
means for receiving the additional information contained in the label data corresponding to the printed label to be used; and
means for checking the received additional information to decide whether the printed label can be used or not.

2. A system according to claim 1, wherein said adding means adds the additional information as bar codes.

3. A system according to claim 1, wherein said adding means adds the additional information as watermark.

4. A system according to claim 1, wherein the additional information includes time information relating to an expiring date of the label, and said checking means checks the expiring date.

5. A system according to claim 4, wherein said adding means creates the time information by using time of sending the label data to the customer.

6. A system according to claim 1, wherein the additional information includes unique information of each label.

7. A system according to claim 6, further comprising means for storing unique information of labels, corresponding to label data sent to the customer, with a tag representing whether each label has been used or not; and wherein said checking means checks the unique information to decide whether the label has been used or not by referring said storing means.

8. A system according to claim 7, further comprising means for renewing the tag stored in said storing means depending upon the decision whether the printed label can be used or not.

9. A system according to claim 6, wherein the additional information further includes product information identifying the product owned by the customer and said checking means checks a combination of the additional information and the product information are checked whether the combination is proper or not.

10. A system according to claim 1, wherein said receiving means receives image data of the printed label and decodes the image data to reproduce the additional data.

11. A system according to claim 10, wherein said receiving means reproduces the additional data by decoding bar codes located on the printed label.

12. A system according to claim 10, wherein said receiving means reproduces the additional data by decoding watermarks embedded on the printed label.

13. A system according to claim 1, further comprising means for sending a massage to warn the customer that the label data cannot be used in response to the decision made by said checking means.

14. A system according to claim 1, wherein said creating means creates the label data including data which represents the carrier to return the items and is authorised by the carrier and data which represents the destination to which the items are transferred by the carrier and a name of the customer.

15. A set of computer programmes to be used for returning items; comprising
programme for creating label data representing a label to be printed and to be used for returning items from a customer;
programme for adding additional information on the label data to be used for restricting usage of the label;
programme for sending the label data to a customer;
programme for receiving the additional information contained in the label data corresponding to the printed label to be used; and
programme for checking the received additional information to decide whether the printed label can be used or not.

16. A set of computer programmes according to claim 15, wherein the additional information is added by bar codes.

17. A set of computer programmes according to claim 15, wherein the additional information is added by watermarking.

18. A set of computer programmes according to claim 15, wherein time additional information includes time information relating to an expiring date of the label, and said checking means checks the expiring date.

19. A set of computer programmes according to claim 18, wherein the time information is created by using time of sending the label data to the customer.

20. A set of computer programmes according to claim 15, wherein the additional information is unique of each label.

21. A set of computer programmes according to claim 20, wherein the unique information of the label is used for checking whether the label has been used or not by referring a stored tag in association with the unique information corresponding to label data sent to the customer.

22. A set of computer programmes according to claim 21, further comprising programme for renewing the stored tag depending on the decision whether the printed label can be used or not.

23. A set of computer programmes according to claim 19, wherein the label information further includes product information identifying product owned by the customer and combination of the additional information and the product information are checked whether the combination is proper or not.

24. A set of computer programmes according to claim 15, wherein image data of the printed label is received by the receiving programme and the image data is decoded to reproduce the additional data by the checking programme.

25. A set of computer programmes according to claim 24, wherein the additional data is reproduced by decoding bar codes located on the printed label.

26. A set of computer programmes according to claim 24, wherein the additional data is reproduced by decoding watermarks embedded on the printed label.

27. A set of computer programmes according to claim 15, further comprising programme for sending a massage to warn the customer that the label data cannot be used in response to the decision made by said checking programme.

28. A device for handling data to be used for returning items, the device being connected to a network to which a device of a customer is connected, the device comprising;
a label creator for creating label data representing a label to be printed by the customer and to be used for returning items from a customer;
an adder for adding additional information on the label data to be used for restricting usage of the label;
a sender for sending the label data to a customer;
a receiver for receiving the additional information contained in the label data corresponding to the printed label to be used; and
a checker for checking the received additional information to decide whether the printed label can be used or not.

29. A device according to claim 28, wherein said adder adds unique information for each label sent to the customer by non-visible way.

30. A device according to claim 29, wherein the label information further includes product information identifying the product owned by the customer, and said checker checks whether combination of the unique information and the item information is proper or not.

31. A device according to claim 28, further comprising a sender for sending a massage to warn the customer that the label data cannot be used in response to the decision made by said checker.

32. A device for handling data to be used for returning items, the device being connected to a network to which a device of manufacturer is connected, the device of manufacturer sending label data presenting a label to be printed and to be used for returning items from a customer with unique information for each label to the network, the device comprising;
a scanner for scanning a printed label to obtain image data corresponding thereto;
a sender for sending the image data to the device of manufacturer so that the image data is to be checked; and
a receiver for receiving the result of checking whether the unique information contained in the image data of the printed label can be used or not from the device of manufacturer.

33. A device for handling data to be used for returning items, the device being connected to a network to which a device of manufacturer is connected, the device of manufacturer sending label data presenting a label to be printed and to be used for returning items from a customer with unique information for each label to the network, the device comprising;
a reader for reading a printed label to obtain the unique information corresponding thereto;
a sender for sending the unique information to the device of manufacturer so that the unique information is to be checked; and
a receiver for receiving the result of checking whether the unique information of the printed label can be used or not from the device of manufacturer.

34. A system for handling data to be used for returning items; comprising
means for creating label data representing a label to be printed for returning an item from a customer, the label data including unique data;
means for sending the label data to a customer;
means for receiving identification data identifying an item to be returned by the customer;
means for storing the identification data in association with the unique data;
means for receiving identifying data from a returned item;
means for checking the received identifying data from the returned item to decide whether the returned item is proper or not by referring the identification data stored in said storing means; and
means for calling the unique data associating with the identification data if said checking means decides that the returned item is improper.

35. A system according to claim 34, wherein the label data further includes customer data regarding the customer and said calling means calls the customer data together with the unique data.

36. A system according to claim 35, further comprising means for sending a massage to warn the customer by using the customer data corresponding to the identifying data checked by said checking means as the returned item corresponding to the identifying data is improper.

37. A system according to claim 34, further comprising means for sending the decision made by said checking means to a place where the returned items are handled so that the returned item is to be recycled.

38. A system according to claim 34, wherein said checking means checks the received identifying data from the returned item to decide whether the identification data corresponding thereto is stored in said storing means or not.

39. A system according to claim 38, wherein said checking means further checks whether the returned item has been previously returned or not by referring the identification data stored in said storing means

40. A system according to claim 39, wherein said storing means stores identification data with a tag representing whether each item has been returned or not; and further comprising renewing means for renewing the tag stored in said storing means in response to the decision that the returned item is proper.

41. A set of computer programmes for handling data to be used for returning items; comprising
programme for creating label data representing a label to be printed for returning an item from a customer, the label data including unique data;
programme for sending the label data to a customer;
programme for receiving identification data identifying an item to be returned by the customer;
programme for storing the identification data in association with the unique data in a storage;
programme for receiving identifying data from a returned item;
programme for checking the received identifying data from the returned item to decide whether the returned item is proper or not by referring the identification data stored by storing means; and
programme for calling the unique data associating with the identification data if said checking means decides that the returned item is improper.

42. A set of computer programme according to claim 41, wherein the label data further includes customer data regarding the customer and said calling programme causes to call the customer data together with the unique data.

43. A set of computer programme according to claim 42, further comprising programme for sending a massage to warn the customer by using the customer data corresponding to the identifying data checked by said checking programme as the returned item corresponding to the identifying data is improper.

44. A set of computer programme according to claim 41, further comprising programme for sending the decision made by said checking programme to a place where the returned items are handled so that the returned item is to be recycled.

45. A set of computer programme according to claim 41, wherein said checking programme causes to check the received identifying data from the returned item to decide whether the identification data corresponding thereto is stored in the storage or not.

46. A set of computer programme according to claim 45, wherein said checking programme further causes to check whether the returned item has been previously returned or not by referring the identification data stored in the storage

47. A set of computer programme according to claim 46, wherein said storing programmes cause sot store identification data with a tag representing whether each item has been returned or not in the storage; and further comprising renewing means for renewing the tag stored in the storage in response to the decision made by said checking programme that the returned item is proper.

48. A device for handling data to be used for returning items; comprising
a label creator for creating label data representing a label to be printed for returning an item from a customer, the label data including unique data;
a sender for sending the label data to a customer;
a receiver for receiving identification data identifying an item to be returned by the customer;
a storage for storing the identification data in association with the unique data;
a receiver for receiving identifying data from a returned item;
a checker for checking the received identifying data from the returned item to decide whether the returned item is proper or not by referring the identification data stored in said storage; and
a caller for calling the unique data associating with the identification data if said checker decides that the returned item is improper.
